(19) United States
(12) Patent Application Publication
(10) Pub. No.: US 2003/0210267 A1
(43) Pub. Date: Nov. 13, 2003

(54) Systems and methods for providing asynchronous client rendering in a graphical user interface (GUI) environment

(76) Inventors: Robert Lee Kylberg, Palo Alto, CA (US); Padmaja Adusumilli, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/144,468

(22) Filed: May 13, 2002

(51) Int. Cl. G09G 5/00

(52) U.S. Cl. 345/762

(57) ABSTRACT

Systems and methods for providing asynchronous client rendering for a graphics systems in a graphical user interface (GUI) are provided. One embodiment is a method for providing asynchronous client rendering for a graphics system in a graphical user interface (GUI) environment. Briefly described, one such method comprises the steps of: rendering a component associated with a graphics system to a first buffer; rendering at least one graphical element associated with a client of the graphics system to a second buffer; and generating a composition of the first buffer and the second buffer.

### TECHNICAL FIELD

The present invention is generally related to rendering components in a graphical user interface (GUI) environment and, more particularly, is related to mechanisms supported by a GUI for enabling a client application to customize a component by rendering graphics within the component.

### BACKGROUND OF THE INVENTION

Currently, a variety of computer systems support a graphics system, such as a graphical user interface (GUI) environment. Many such graphics systems support the rendering of components (e.g., windows, menus, buttons, icons, etc.). In these types of graphics systems, it may be advantageous to provide resources to client applications. For example, these resources may include one or more mechanisms that enable client applications to render graphical elements (e.g., points, lines, circles, other graphics primitives, etc.) onto the components. This enables client applications to customize or change the appearance of components that the applications use.

Making the graphics elements that applications render persistent is an important consideration for designers of graphics systems. Persistence means that rendered graphics elements continue to be correctly displayed even as conditions within the graphics system change. As an example, consider the case where an application renders onto the surface of a window. If that window is later resized or otherwise changed, it is important that the rendered graphics continue to be correctly depicted.

Some graphics systems support application rendering of components by enabling applications to directly render into the portions of screen memory (e.g., frame buffer or other memory directly associated with a display device) that correspond to the components that the applications have rendered. One advantage of this technique is that it requires no additional memory to support application rendering of components. Unfortunately, this form of direct rendering offers little persistence. For example, if the size of a component is reduced, any rendering outside of the new bounds is lost. If the size of a component is increased, the newly exposed area is left blank or, in some cases, the entire component becomes blank. This form of direct rendering may also be problematic because it cannot be used to render components that are not currently on-screen (i.e., it cannot be used for components that are “visible” but not showing) where the components are located outside of the bounds of the display device. For instance, direct single on-screen rendering into such off-screen “visible” components has no effect.

The limitations of direct rendering may be partially overcome by requiring applications to regenerate on-component graphics whenever necessary. This approach is undesirable because it forces applications to maintain enough visual state information to be able to regenerate the rendered graphics when necessary.

More robust graphics systems support application rendering of components by providing component-owned double buffers. Each double buffer is a memory buffer that corresponds to the visible representation of the owning component. Components and applications share access to double buffers. For many implementations, sharing means that components first render into their double buffers and then notify client applications. The client applications then perform their own rendering into the component double buffers. For other implementations, client applications are provided with a reference or pointer to component double buffers (i.e., cache the components graphics context).

The use of double buffers overcomes some of the difficulties of direct single buffer component rendering. In particular, with double buffers, components do not have to be on-screen to be rendered. On the other hand, sharing of double buffers between components and applications tends to lead to undesirable visual states. As a result, systems that use double buffers for component rendering often enforce a strict rendering order between components and client applications. An additional limitation of the double buffering technique is that it is not possible to modify component attributes, such as background color, without clearing the visual state of the component.

Thus, there is a need in the industry for improved mechanisms for providing client rendering in graphics systems.

### SUMMARY OF THE INVENTION

One embodiment of the present invention provides a method for providing asynchronous client rendering for a graphics system in a graphical user interface (GUI) environment. Briefly described, one such method comprises the steps of: rendering a component associated with a graphics system to a first buffer; rendering at least one graphical element associated with a client of the graphics system to a second buffer; and generating a composition of the first buffer and the second buffer.

Another embodiment of the present invention provides a computer program embodied in a computer-readable medium for providing asynchronous client rendering for a graphics system in a graphical user interface (GUI) environment. Briefly described, one such computer program comprises: logic configured to render a component associated with a graphics system to a first buffer; logic configured to render at least one graphical element associated with a client of the graphics system to a second buffer; and logic configured to generate a composition of the component and the at least one graphical element.

Another embodiment of the present invention provides an asynchronous client rendering system for a graphics system in a graphical user interface (GUI) environment. Briefly described, in architecture, one such system comprises: memory comprising at least one component buffer configured to store a graphics context associated with a component and at least one transparent client buffer configured to store a graphics context for at least one graphical element associated with a client of a graphics system; a component interface configured for enabling the component to be rendered to the at least one component buffer; a client interface configured to enable the at least one graphical element to be rendered to the at least one component buffer; and a component composition mechanism configured to generate a composition of the component and the at least one graphical element.

Briefly described, another such system comprises: a storage means for storing a graphics context associated with a component and a graphics context for at least one graphical element associated with a client of a graphics system; a first interface means for enabling the component to be rendered to the storage means; a second interface means for enabling the at least one graphical element to be rendered to the storage means; and a means for generating a composition of the component and the at least one graphical element.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an embodiment of a system according to the present invention for providing asynchronous client rendering in a graphics system.

FIG. 2 is a flow chart illustrating the architecture, operation, and/or functionality of the asynchronous client rendering system of FIG. 1.

FIG. 3A is an on-screen representation of an exemplary “button” component that may be implemented in the asynchronous client rendering system of FIGS. 1 and 2.

FIG. 3B illustrates the “button” component of FIG. 3A when a cursor is placed over the component.

FIG. 3C illustrates the “button” component of FIG. 3A when the cursor is placed over the component and is selected.

FIG. 4 is a flow chart illustrating the general operation of the asynchronous client rendering system of FIGS. 1 and 2 according to the present invention.

FIG. 5 is a block diagram illustrating an embodiment of the asynchronous client rendering system of FIGS. 1 and 2 according to the present invention.

FIG. 6 is a flow chart illustrating the architecture, operation, and/or functionality of the asynchronous client rendering system of FIG. 5.

FIG. 7 is a flow chart illustrating one of a number of processes according to the present invention for generating the client buffer in FIG. 6.

FIG. 8 is a block diagram illustrating another embodiment of the asynchronous client rendering system of FIGS. 1 and 2.

FIG. 9 is a flowchart illustrating an algorithm for implementing the asynchronous client rendering system of FIG. 8.

FIG. 10 is a block diagram illustrating a computing system according to the present invention, in which the asynchronous client rendering system of FIGS. 1, 2, and 4-9 may be implemented.

### DETAILED DESCRIPTION

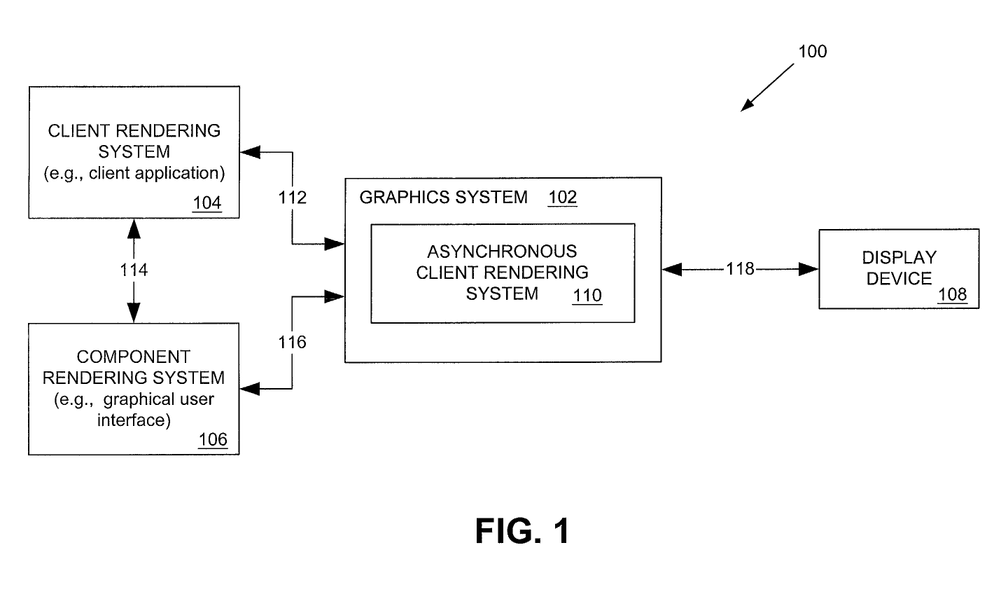

FIG. 1 illustrates an embodiment of a system 100 according to the present invention, which is configured to provide asynchronous client rendering for a graphics system in a graphical user interface (GUI) environment. In this regard, the embodiment of system 100 illustrated in FIG. 1 includes an asynchronous client rendering system 110. The architecture, operation, and/or functionality of various embodiments of asynchronous client rendering system 110 will be described in more detail below. However, by way of introduction, the general architecture, operation, and/or functionality of various embodiments of asynchronous client rendering system 110 will be described with respect to FIGS. 1-4.

As illustrated in FIG. 1, system 100 comprises a graphics system 102, a display device 108, a client rendering system 104, and a component rendering system 106. Graphics system 102 communicates with client rendering system 104 via a client interface 112, with component rendering system 106 via a component interface 116, and with display device 108 via interface 118. As described in more detail below, component rendering system 106 may render various types of components of a GUI (e.g., buttons, windows, taskbars, checkboxes, scrollbars, etc.) to graphics system 102 via component interface 116. As further illustrated in FIG. 1, system 100 also enables a client of component rendering system 106 (i.e., client rendering system 104) to render at least one graphical element (e.g., lines, circles, text, images, shapes, other graphics primitives, etc.) with the graphics context of a particular component being rendered by component rendering system 106. Unlike the component rendering, however, this client rendering is provided via client interface 104. In this manner, asynchronous client rendering system 110 provides a mechanism by which client rendering and component rendering may be independently controlled and/or operated.

Thus, asynchronous client rendering system 110 enables client rendering system 104 to render asynchronously into a graphics context for a particular component without this rendering activity conflicting with component rendering performed by component rendering system 106. In other words, asynchronous client rendering system 110 provides client rendering that is persistent and independent of component rendering. As an example, asynchronous client rendering system 110 enables client rendering system 104 to render into any type of GUI component without regard to issues of synchronization, graphics context scope, and/or without having to retain past rendering state information in order to re-render a component from scratch. Furthermore, asynchronous client rendering system 110 enables GUI applications to be written in a more permissive manner.

As a more specific example, asynchronous client rendering system 110 provides an environment in which component resizing (via component interface 116) by component rendering system 106 does not affect the visual content rendered (via client interface 112) by client rendering system 104. Furthermore, visual state information corresponding to a particular component may be modified without necessitating a re-rendering by client rendering system 104. For instance, the background color of a component may be modified without requiring client rendering system 104 to re-render client graphical element(s).

Referring again to FIG. 1, the various components of system 100 will be described. In general, component rendering system 106 supports a GUI environment by providing one or more mechanisms by which various components (e.g., buttons, windows, taskbars, checkboxes, scrollbars, lists, canvas, labels, panels, scroll panes, text areas, text fields, frames, pop-up menus, dials, file dialogs, menu bars, etc.) of a GUI may be rendered via graphics system 102 and displayed on display device 108. One of ordinary skill in the art will appreciate that component rendering system 106 may support a variety of types of GUIs and, therefore, a variety of types of GUI components. For instance, many current operating systems provide a graphical user interface. Applications typically use the elements of the GUI that come with the operating system and add their own GUI elements. Thus, in one of many possible embodiments, component rendering system 106 may be implemented in combination with an operating system (e.g., Windows®-based operating systems, Macintosh®-based operating systems, etc.). In some of these embodiments, component rendering system 106 may be integrated within the operating system.

Nonetheless, component rendering system 106 need not be implemented with an operating system. As described in greater detail below, in alternative embodiments, component rendering system 106 may be implemented as stand-alone functionality for implementing a GUI, which is configured to support a mechanism for enabling a client application (i.e., client rendering system 104) to render graphical element(s) within the components provided by the component rendering system 106. By way of example, in alternative embodiments, component rendering system 106 may be implemented in a computer programming language, such as a high-level programming language (e.g., Java®, etc.). In further embodiments, component rendering system 106 may be implemented in a windowing toolkit (e.g., Java® Abstract Windowing Toolkit (AWT), etc.), which may comprise a set of machine independent classes, data structures, and methods configured to provide client application(s) with resources to generate graphic user interfaces and outputs.

One of ordinary skill in the art will appreciate that display device 108 may comprise any of the following (or other) types of devices configured to support the graphical user interface: a computer monitor, a liquid crystal display (LCD), a plasma-based display, an LED-based display, a touch-sensitive screen, such as those implemented in portable computing devices (e.g., a personal digital assistant (PDA)), and any other known or future display device, regardless of the underlying display technology. In addition, depending on the configuration of component rendering system 106, client rendering system 104 may comprise any of a variety of types of computer programs, client applications, software mechanisms, etc.

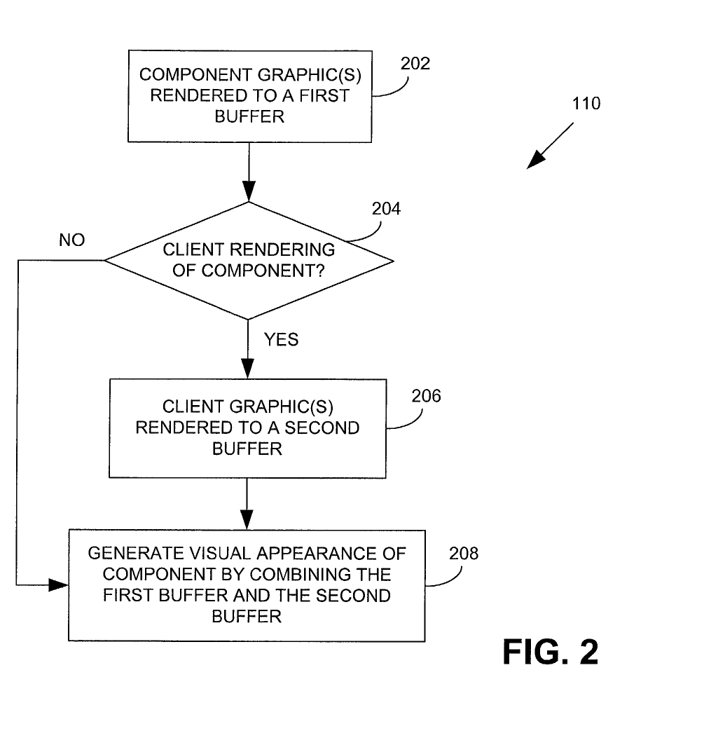

As stated above and illustrated in FIG. 1, asynchronous client rendering system 110 may provide separate interfaces by which client rendering system 104 (client interface 112) and component rendering system 106 (component interface 116) render in graphics system 102. FIG. 2 illustrates the general architecture, operation, and/or functionality of an embodiment of asynchronous client rendering system 110 according to the present invention. At block 202, a particular component associated with a GUI may be rendered to a first graphics buffer associated with component rendering system 106 (i.e., a component buffer). As illustrated in FIG. 1, component rendering system 106 may render the component to the first graphics buffer via component interface 116. At decision block 204, asynchronous client rendering system 110 determines whether the component has any associated client rendering to be performed. If client rendering is not to be performed, flow continues at block 208. However, if client rendering of the component is to be performed, at block 206, the corresponding graphical element(s) are rendered to a second graphics buffer associated with client rendering system 104 (i.e., a client buffer). As illustrated in FIG. 1, client rendering system 104 may render the graphical element(s) to the second graphics buffer via component interface 112. At block 208, asynchronous client rendering system 110 generates a client rendered component by combining the component in the first graphics buffer and the graphical element(s) in the second graphics buffer.

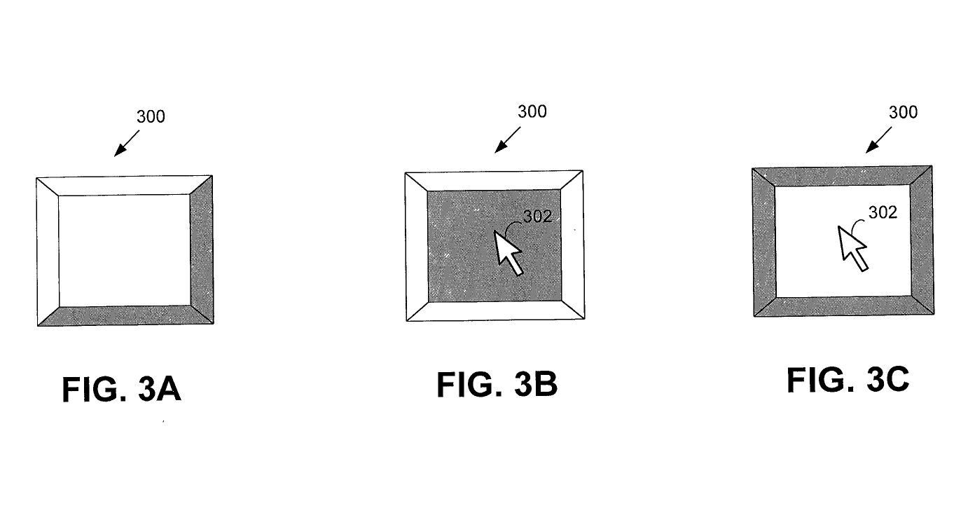

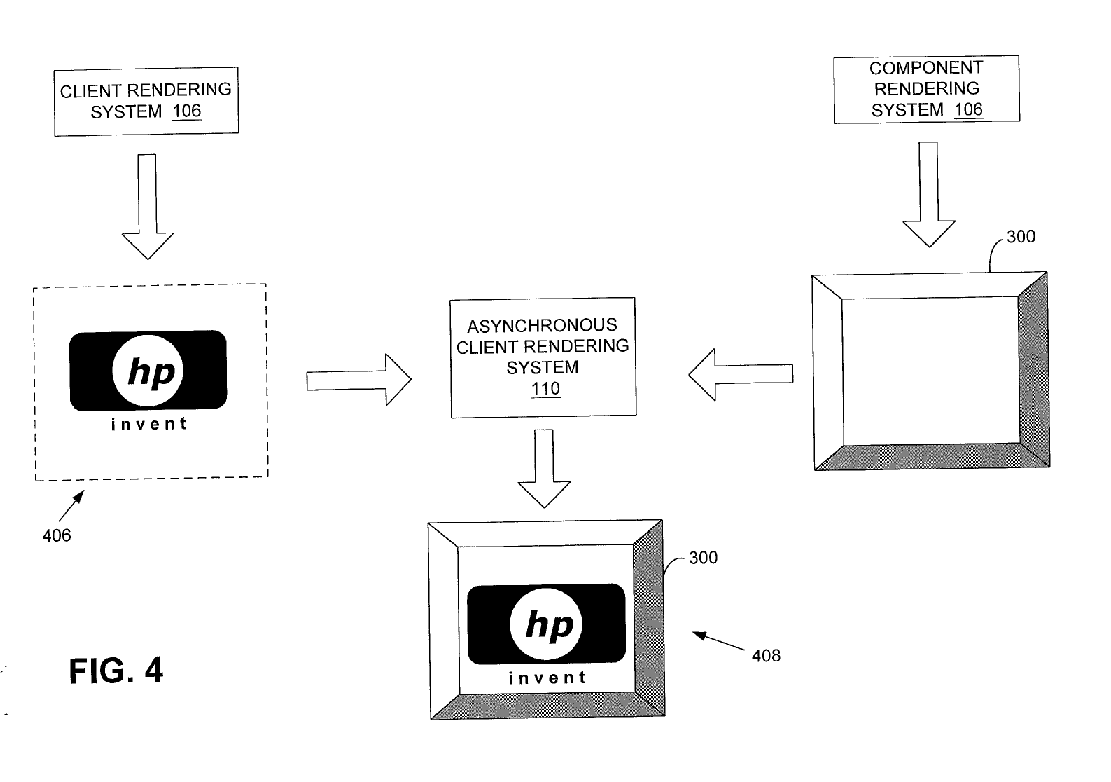

With reference to FIGS. 3 and 4, a nonlimiting example of a “button” component and sample client graphics will be described to further illustrate the architecture, operation, and/or functionality of asynchronous client rendering system 110. As stated above, component rendering system 106 may render various types of components of a GUI. FIGS. 3A-3C illustrate on-screen representations of an exemplary GUI “button” component 300 in various states. FIG. 3A illustrates the button component 300 as it appears in a standard state. FIG. 3B illustrates the button 300 when it has input focus (e.g., where a user has moved a cursor 302 over the button component 300). As illustrated in FIG. 3B, a button 300 with input focus may be visually distinguished, for example, by darkening a portion of the button component 300. FIG. 3C illustrates the button component 300 when the user selects the button (e.g., by clicking a mouse when the cursor 302 is over the button component 300).

As illustrated in FIG. 4, component rendering system 106 may render the component 300 to a component buffer in asynchronous client rendering system 110. Furthermore, client rendering system 104 may render any of a variety of types of graphical element(s) to a client buffer in asynchronous client rendering system 110. In the exemplary embodiment illustrated in FIG. 4, the graphical element(s) rendered by client rendering system 104 comprise a client graphic 406 of a corporate logo/trademark. As further illustrated in FIG. 4, asynchronous client rendering system 110 generates a client rendered component 408 by combining client graphic 406 and component 300. One of ordinary skill in the art will appreciate that the client graphic 406 and component 300 may be combined in a variety of ways. For example, client graphic 406 and component 300 may be superimposed, overlapped, overlayed, etc. to generate the client rendered component. In one embodiment, the client graphic 406 and component 300 are stored in their respective buffers as bitmap or pixel map images and combined by overlapping the images, for example, as described by Pike in Graphics in Overlapping Bitmap Layers, Computing Science Technical Report No. 999, AT&T Bell Laboratories, Apr. 1, 1983, which is hereby incorporated by reference in its entirety. Nonetheless, one of ordinary skill in the art will appreciate that the client graphic 406 and component 300 may be stored in their respective buffers in any of a variety of alternative ways and, therefore, asynchronous client rendering system 110 may also generate the composition in a variety of alternative ways.

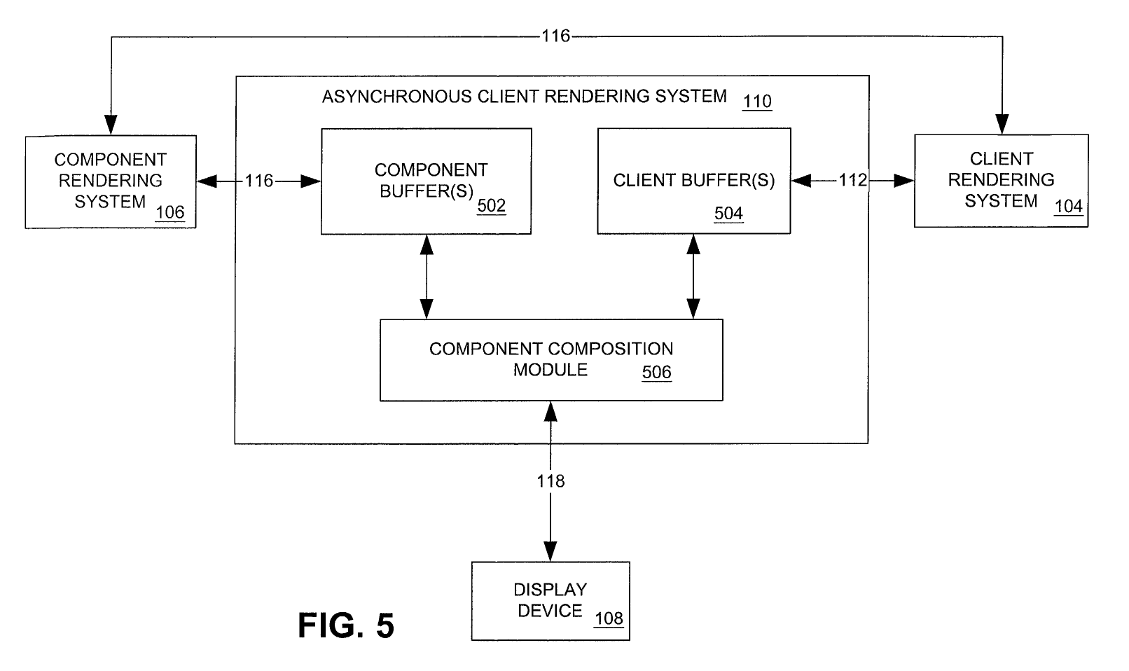

FIG. 5 illustrates one of a number of possible embodiments of asynchronous client rendering system 110 according to the present invention. In the embodiment illustrated in FIG. 5, asynchronous client rendering system 110 comprises at least one component buffer 502, at least one client buffer 504, and a component composition module 506. Component rendering system 106 interfaces with the component buffer(s) 502 via component interface 116. Client rendering system 106 interfaces with client buffer(s) 504 via client interface 112. As known in the art, client buffer(s) 504 and component buffer(s) 502 contain a representation of an image that is to be displayed on display device 108. Thus, client buffer(s) 504 contain the visual state information corresponding to the graphical element(s) to be rendered by client rendering system 104 and component buffer(s) 502 contain the visual state information corresponding to particular components to be rendered by component rendering system 106. One of ordinary skill in the art will appreciate that component buffer(s) 502 and client buffer(s) 504 may be configured in a variety of ways to store this information. For example, buffers 502 and 504 may be configured as bitmaps, pixel maps, etc. Furthermore, in certain embodiments, client buffer(s) 504 may be configured to store client rendering as a transparent image, in which pixels not being used to generate the graphical element(s) are represented as transparent pixels. In this manner, the graphical element(s) and the component may be more easily combined. Component composition module 506 comprises the logic configured to generate the composition of the graphical element(s) stored in a client buffer 504 and the corresponding component stored in a component buffer 502. One of ordinary skill in the art will appreciate that this functionality may be performed in a variety of ways. Furthermore, component composition module 506 interfaces with buffers 502 and 504, as well as with display device 108 via interface 118.

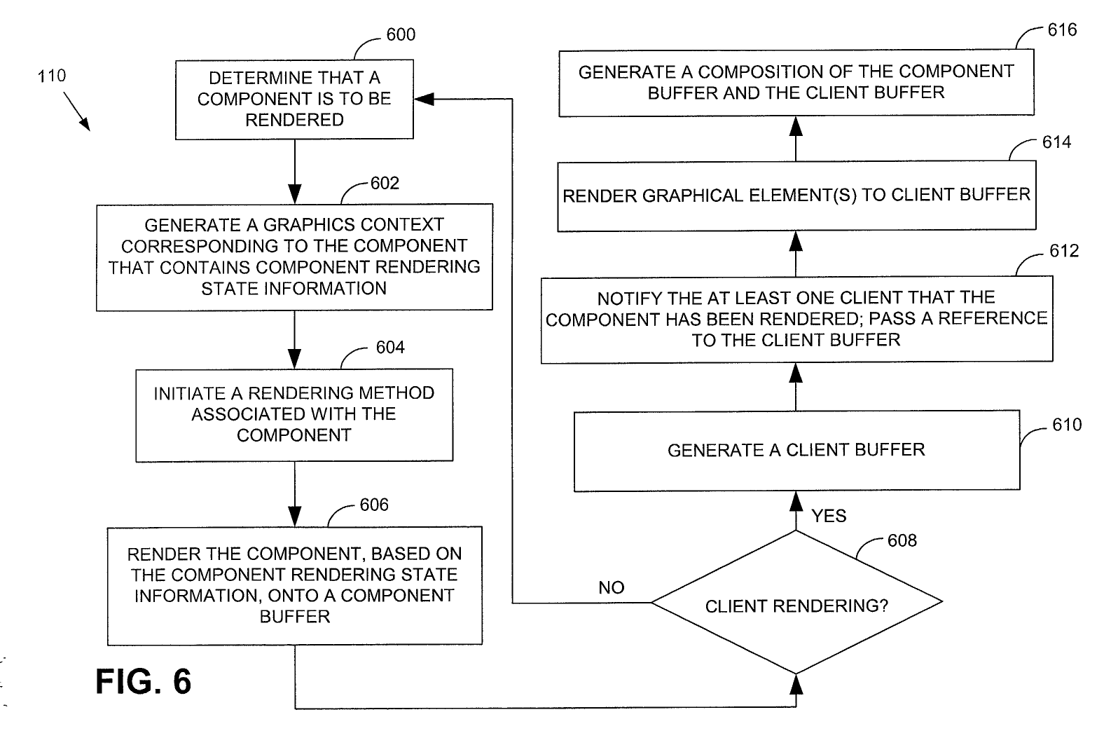

FIG. 6 is a flow chart illustrating the architecture, operation, and/or functionality of another embodiment of asynchronous client rendering system 110. At block 600, asynchronous client rendering system 110 determines that a component associated with a GUI is to be rendered by component rendering system 106. At block 602, asynchronous client rendering system 110 generates a graphics context corresponding to the component, which contains component rendering state information. At block 604, asynchronous client rendering system 110 initiates a rendering method associated with the component to be rendered. At block 606, asynchronous client rendering system 110 renders the component into a component buffer 502 based on the component rendering state information in the graphics context. By way of example, many graphics systems employ two mechanisms to render a component: (1) a graphics context that contains the component rendering state information; and (2) a rendering method that uses the graphics context to render the component. In this manner, the rendering method may import the information in the graphics context to render the component.

At decision block 608, asynchronous client rendering system 110 determines whether any client graphical element(s) are to be rendered with the component. In other words, asynchronous client rendering system 110 determines whether a client rendering system 104 is going to perform client rendering. If no client rendering is to be performed, flow continues to block 600. However, if client rendering is to be performed, at block 610, asynchronous client rendering system 110 generates a client buffer 504 for the client rendering system 104. At block 612, asynchronous client rendering system 110 notifies the client rendering system 104 that the corresponding component has been rendered. Asynchronous client rendering system 110 may pass a reference to the client rendering system 104 of the appropriate client buffer 504 generated at block 610. At block 614, asynchronous client rendering system 110 renders the graphical element(s) to the appropriate client buffer 504. At block 616, asynchronous client rendering system 110 generates a composition of the client buffer 504 and component buffer 502.

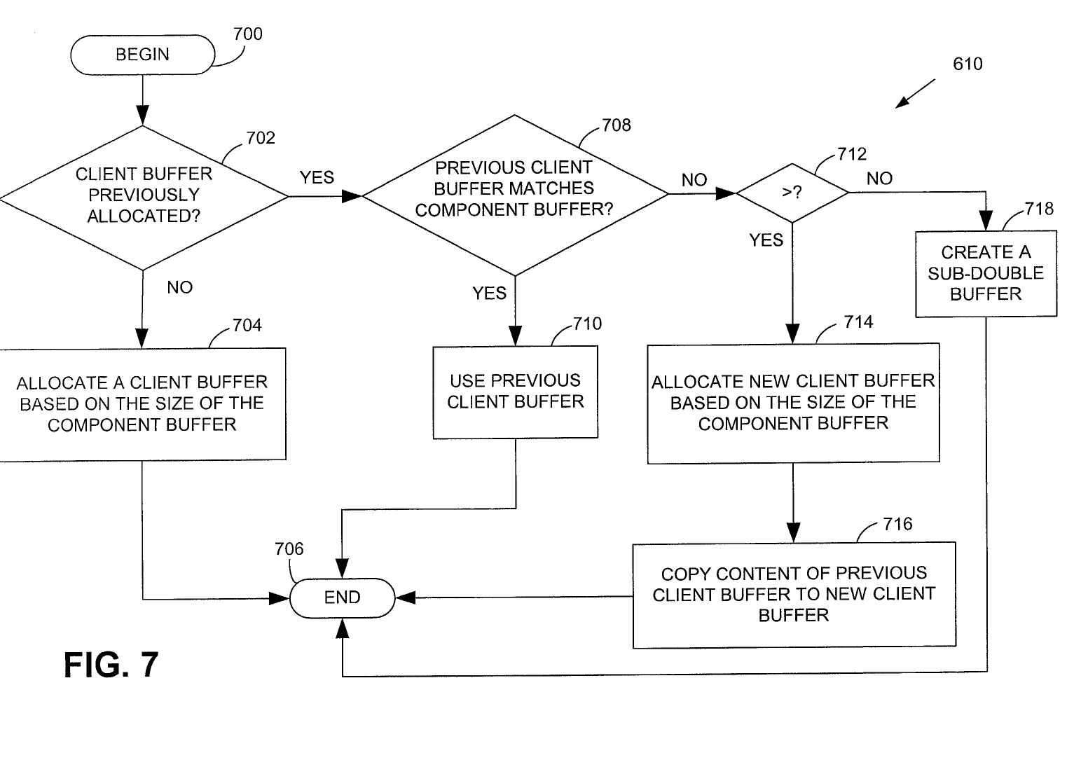

As stated above, asynchronous client rendering system 110 provides an environment in which component resizing by component rendering system 106 does not affect the visual content rendered by client rendering system 104. Furthermore, visual state information corresponding to a particular component may be modified without necessitating a re-rendering by client rendering system 104. For instance, the background color of a component may be modified without requiring client rendering system 104 to re-render client graphical element(s). In this regard, FIG. 7 is a flow chart illustrating one of a number of processes according to the present invention for implementing the functionality of block 610 in FIG. 6.

Referring to FIG. 7, the process begins at block 700. At decision block 702, asynchronous client rendering system 110 determines whether a client buffer 504 was previously allocated for the corresponding component buffer. If a client buffer 504 was not previously allocated, at block 704, asynchronous client rendering system 110 allocates a client buffer 504 based on the size of the current component buffer 502. If a client buffer 504 was not previously allocated, at decision block 708, asynchronous client rendering system 110 determines whether the previously-allocated client buffer 504 matches the current component buffer 702. In other words, asynchronous client rendering system 110 determines whether the client buffer 502 needs to be modified because of the most recent component rendering. If the previously-allocated client buffer 504 matches the current component buffer 502, at block 710, asynchronous client rendering system 110 determines that the previously-allocated client buffer 504 should be used.

If the previously-allocated client buffer 504 does not match the current component buffer 502, at decision block 712, asynchronous client rendering system 110 determines whether the size of the previously-allocated client buffer 504 is greater than the current component buffer. If the previously-allocated client buffer 504 is greater, at block 714, asynchronous client rendering system 110 allocates a new client buffer 504 based on the size of the current component buffer 502. At block 716, asynchronous client rendering system 110 copies the content of the previous-allocated client buffer 504 to the new client buffer 504. Referring again to decision block 712, if the previously-allocated client buffer 504 is not greater, at block 718, asynchronous client rendering system 110 creates a sub-buffer within the previously-allocated client buffer 504. One of ordinary skill in the art will appreciate that sub-buffer utilization may improve system performance by reducing the need for memory allocations and reduce computational overhead by eliminating the need to copy data. Furthermore, the accumulation of rendering on the sub-buffer persists when the component is resized, which may be desirable.

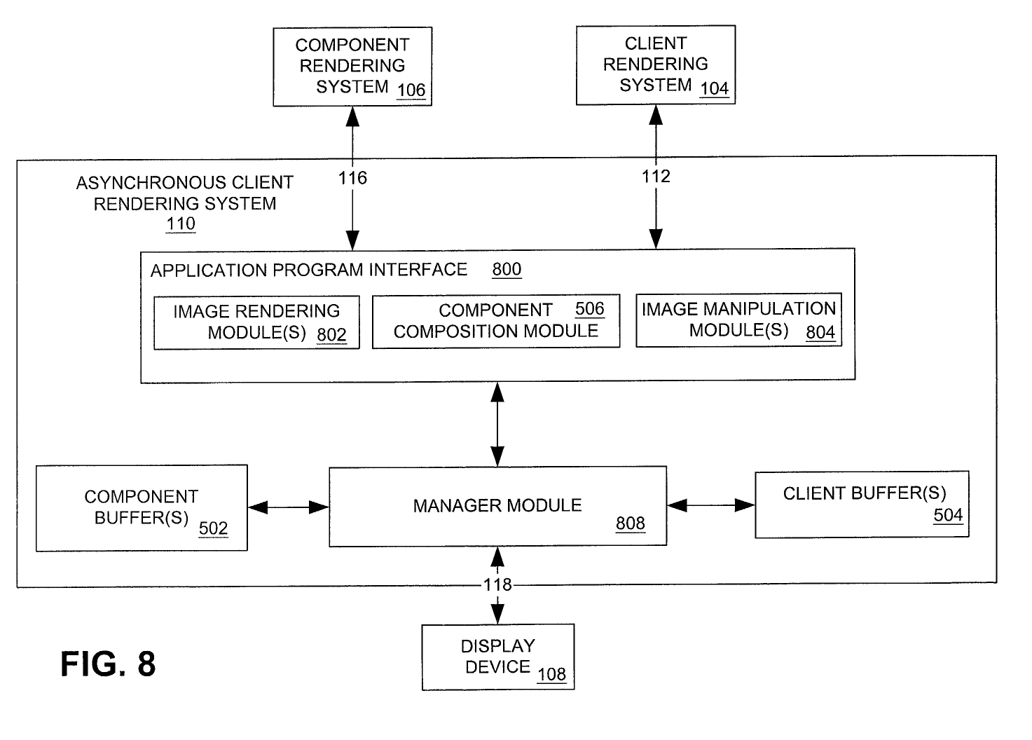

FIG. 8 is a block diagram illustrating another embodiment of asynchronous client rendering system 110. In the embodiment illustrated in FIG. 8, asynchronous client rendering system 110 comprises component buffer(s) 502, client buffer(s) 504, manager module 808, and an application program interface 800. Client buffer(s) 504 and component buffer(s) 502 may be configured in much the same manner as described above.

One of ordinary skill in the art will appreciate that manager module 808 comprises the logic configured to control and/or manage communications between component rendering system 106 and client rendering system 104 via interfaces 116 and 112. In other words, manager module 808 controls which system (i.e., component rendering system 106 or client rendering system 104) has control over application program interface 800.

One of ordinary skill in the art will further appreciate that application program interface 800 may comprise any of a variety of types of software mechanisms that can be referenced by component rendering system 106 and/or client rendering system 104 to access the services described above, which are provided by asynchronous client rendering system 110. For example, in certain embodiments, application program interface 800 may implement function(s), call(s), routine(s), data structure(s), data type(s), statement(s), class(es), object(s), etc. to provide the asynchronous client rendering services. In the embodiment illustrated in FIG. 8, application program interface 800 comprises image rendering module(s) 802, component composition module 506, and image manipulation module(s) 804.

Image rendering module(s) 802 may comprise logic configured to render appropriate component and/or client graphics. For example, image rendering module(s) 802 may include a render method (“render ( )” ). One of ordinary skill in the art will appreciate that component rendering system 106 and/or client rendering system 104 may render graphics by calling the render method and by passing a specific graphics context to application program interface 800.

Image manipulation module(s) 804 may comprise logic configured to manipulate the images stored in client buffer(s) 504 and component buffer(s) 502. In certain embodiments, this functionality may be implemented by calling a particular method configured to edit/manipulate images stored in buffers 502 and 504 by passing certain related parameters to application program interface 800. Component composition module 506 may configured in much the same manner as described above with respect to FIG. 5.

One of ordinary skill in the art will appreciate that asynchronous client rendering system 110 may be implemented in a variety of alternative ways. For instance, in an alternative embodiment, asynchronous client rendering system 110 and/or application program interface 800 may be implemented by defining a set of data structures, a class, and a set of methods.

In one alternative embodiment, asynchronous client rendering system 110 may define a “Surface” data structure that contains a system dependent representation of an image (or image portion). The data values included in the surface data structure may be modified when graphical elements are rendered into the surface data structure.

Asynchronous client rendering system 110 may also define a “GraphicsContext” data structure that may be created by a “Component” class (described below). The GraphicsContext data structure may contain component rendering state information, such as, but not limited to, any of the following: foreground color of the component, background color of the component, font, size of the component, etc. The GraphicsContext data structure may also include a pointer, reference, etc. to a valid Surface data structure. The combination of the Surface data structure and the GraphicsContext data structure may provide an abstract interface for rendering into a particular Surface data structure. One of ordinary skill in the art will appreciate that alternative implementations may be implemented.

As mentioned above, asynchronous client rendering system 110 may define a “Component” class that implements any of a variety of methods for providing the asynchronous client rendering services. For example, in certain embodiments, the Component class may implement the following methods:

TABLE 1

| Output | Method |
|---|---|
| boolean | ClientRenderEnabled(); |
| Graphics- | getGraphics(GraphicsContext default); |
| Context | |
| Void | paint(GraphicsContext gc); |
| Void | NotifyPaintClient(GraphicsContext gc); |
| Void | ComponentComp (GraphicsContext source, GraphicsCon- |
| | text dest); |

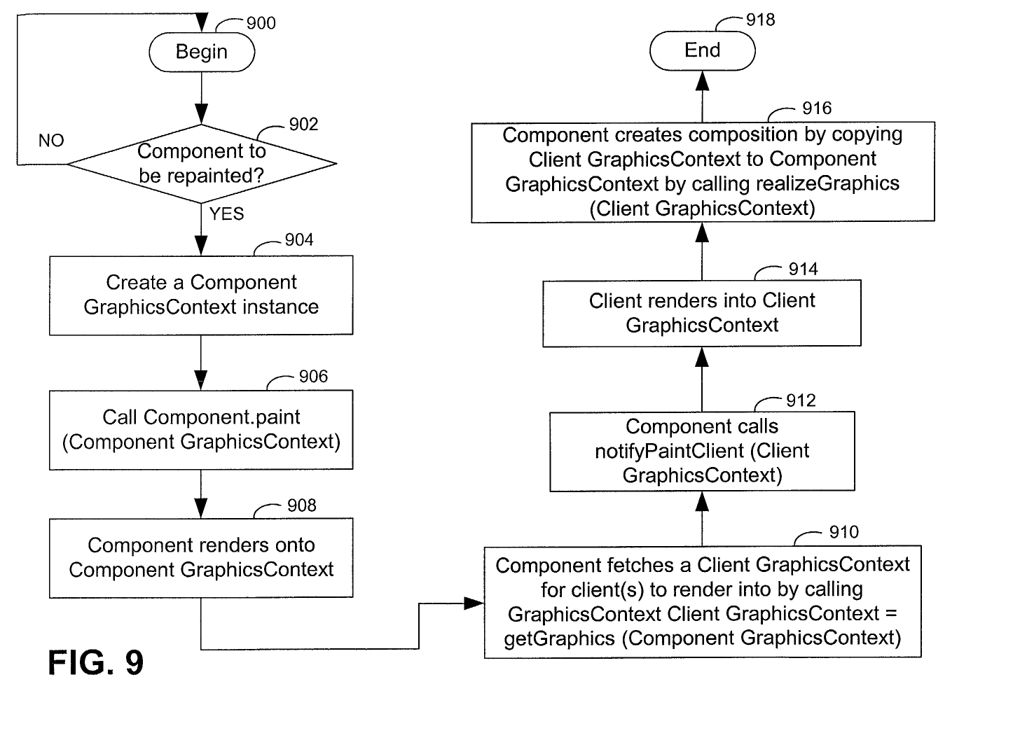

FIG. 9 is a flow chart illustrating an algorithm for implementing asynchronous client rendering system 110 with the mechanisms identified in Table 1. The algorithm begins at block 900. At decision block 902, asynchronous client rendering system 110 determines whether a particular component is to be repainted. When a component is to be repainted, at block 904, a Component GraphicsContext instance is created for the component. One of ordinary skill in the art will appreciate that the Surface associated with the component is based on the current on-screen visual state of the component. Furthermore, an instance of the Component class may be created for each component. Asynchronous client rendering system 110 may interact with these instances to provide the asynchronous client rendering services. A more detailed description of the interaction between component instances and asynchronous client rendering system 110 follows. Referring again to FIG. 9, one of ordinary skill in the art will appreciate that there are a number of manners in which asynchronous client rendering system 110 may detect that a component requires painting. For example, this determination may be made where a component has been resized or otherwise changed or when a component is initially created.

At block 906, asynchronous client rendering system 110 initiates the paint method to render the component by calling Component.paint (Component GraphicsContext). Based on the current state of the component, the component's paint method renders the visual appearance of the component onto the Surface for Component GraphicsContext. For example, after detecting that a component requires painting, asynchronous client rendering system 110 may respond by encapsulating information to represent the current on-screen visual state of the component. The encapsulated information may comprise, for example, any of the following or other types of information: the current foreground color; the portion of the component to be drawn; the rendering destination, etc. The rendering destination is the destination where rendering operations will occur. In one of a number of embodiments, the rendering destination comprises a reference to a bitmap, pixel map, a memory location, etc. In certain embodiments, there may be situations (e.g., where output is directed at a POSTSCRIPT stream) where a non-bitmap destination may be used.

To perform the encapsulation process, asynchronous client rendering system 110 may create a new GraphicsContext and a new Surface. Asynchronous client rendering system 110 may initialize the Surface of the new GraphicsContext to reference the new Surface. Asynchronous client rendering system 110 may similarly initialize any of the above-referenced data fields in the new GraphicsContext to reflect the current on-screen visual state of the component.

After creating and initializing the GraphicsContext and the Surface, asynchronous client rendering system 110 may call the paint method for the component. Asynchronous client rendering system 110 may pass the newly created component GraphicsContext (and implicitly the newly created component Surface) to the paint method as part of this call. This may notify the component that it needs to render itself based on its current on-screen visual state. The component may respond to the call through a component paint method, which renders onto the component Surface. The paint method may perform this rendering to reflect the state of component or other conditions. This allows the paint method to customize the appearance of the component. For example, consider the situation in which the component is a Button component as illustrated in FIGS. 3A-3C. In this situation, the Button component may render the component Surface differently depending on the current state of the component (e.g., whether the button is pressed or not).

At block 910, the component fetches a GraphicsContext for any client(s) that are to perform client rendering onto the component. This may be performed by making a call to GraphicsContext clientGraphicsContext=getGraphics (Component GraphicsContext). At block 912, a client may be notified that the Client GraphicsContext has been fetched by calling notifyPaintClient(Client GraphicsContext). At block 914, the client may then render any graphical element(s) into Client GraphicsContext. For example, after performing the component rendering, the component paint method may call the getGraphics method and pass the GraphicsContext and Surface discussed above. The getGraphics method may generate and return a second GraphicsContext and a second Surface, referred to as the Client GraphicsContext and the Client Surface. The getGraphics method may initialize the Client GraphicsContext to reflect the Component GraphicsContext. In other words, the Client GraphicsContext represents the current on-screen visual state of the component. The paint method may then fill the Client Surface with a transparent color for graphics system 102.

After creating and initializing the Client GraphicsContext and Client Surface, the component may call the notifyPaintClient method for the component. The newly created Client GraphicsContext (and, implicitly the newly created Client Surface) may be passed to the notifyPaintClient method as part of this call. The notifyPaintClient method may inform client rendering system 104 that it may perform its own rendering of the component. To perform client rendering, client rendering system 104 may add any of a variety of graphical element(s) to Client Surface. As noted above, the Client Surface is initialized to be transparent. As a result, the Client Surface is only modified where graphic element(s) are added. Other areas within Client Surface remain transparent. During this process, client rendering system 104 may cache a reference to Client GraphicsContext (and, implicitly Client Surface), thereby providing client rendering system 104 with a reference that may be used for asynchronous rendering of the component.

At block 916, asynchronous client rendering system 110 generates a component composition by copying Client GraphicsContext to Component GraphicsContext by calling realizeGraphics(Client GraphicsContext, Component GraphicsContext). For example, after client rendering is completed, the component may call the realizeGraphics method and pass the component GraphicsContext and the Client GraphicsContext to the method. The realizeGraphics method may composite the Surfaces referenced by the GraphicsContexts. In order to composite the two Surfaces, the realizeGraphics method may combine the contents of Client Surface and the Component Surface, thereby combining the rendering performed by client rendering system 104 and component rendering system 106. The combination of these two separate renderings results in the on-screen visual state of the component, which may be transferred to display device 108.

Although not necessary, following block 916, a component may want to perform more rendering to ensure that certain graphical elements are always visible. For example, after block 916, a window component may render a string, such as, “Untrusted Window.” The algorithm terminates at block 918.

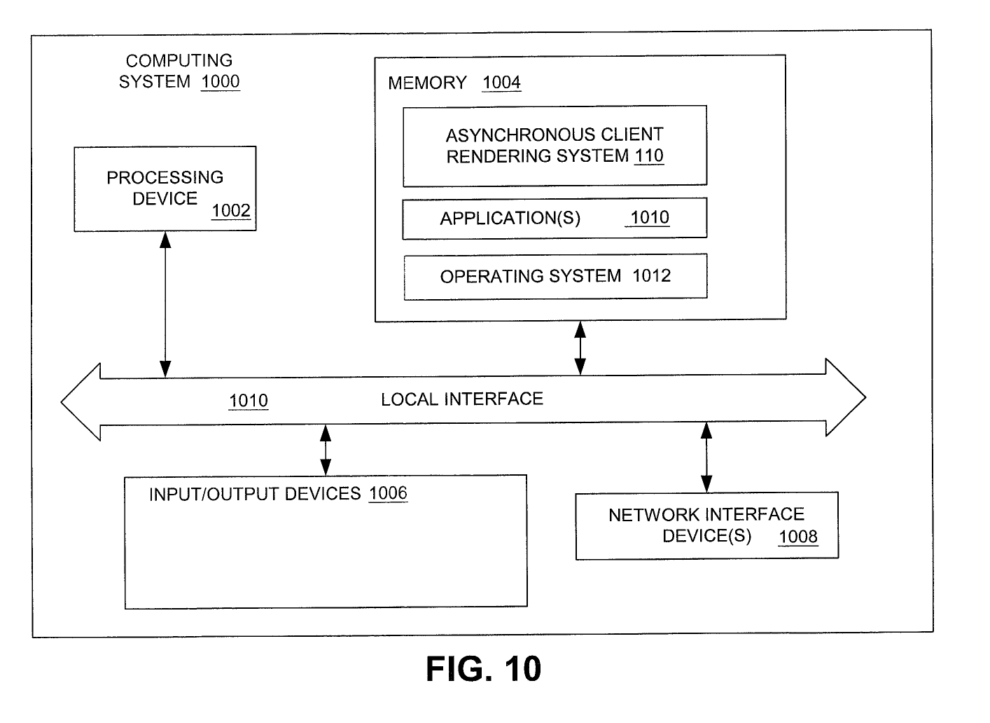

FIG. 10 illustrates a block diagram of an example computer system 1000, in which asynchronous client rendering system 110 may be implemented. Generally speaking, the computer system 1000 may comprise any one of a wide variety of wired and/or wireless computing devices, such as a desktop computer, portable computer, dedicated server computer, multi-processor computing device, cellular telephone, personal digital assistant (PDA), handheld or pen-based computer, and so forth. Irrespective of its specific arrangement, the computer system 1000 can, for instance, comprise a processing device 1002, memory 1004, one or more input/output devices (including display device 108), and one or more networking devices 1008, each of which is connected to a local interface 1010.

The processing device 1002 can include any custom-made or commercially-available processor, a central processing unit (CPU) or an auxiliary processor among several processors associated with the computer system 900, a semiconductor-based microprocessor (in the form of a microchip), a macroprocessor, one or more application-specific integrated circuits (ASICs), a plurality of suitably-configured digital logic gates, and other well known electrical configurations comprising discrete elements both individually and in various combinations to coordinate the overall operation of the computing system.

The memory 1004 can include any one of a combination of volatile memory elements (e.g., random access memory (RAM, such as DRAM, SRAM, etc.)) and nonvolatile memory elements (e.g., ROM, hard drive, tape, CDROM, etc.). The memory 1004 typically comprises an operating system 1012, one or more applications 1014, and asynchronous client rendering system 110 as described above. One of ordinary skill in the art will appreciate that the memory 1004 can, and typically will, comprise other components which have been omitted for purposes of brevity.

The one or more I/O devices 1006 may comprise those components with which the user can interact with the computing system 1000. For example, where the computing system 1000 comprises a personal computer (PC), these components can comprise a keyboard and mouse. Where the computing system 1000 comprises a handheld device (e.g., PDA, mobile telephone), these components can comprise function keys or buttons, a touch-sensitive screen, a stylus, etc.

With further reference to FIG. 10, the one or more I/O devices 1006 may also be adapted to facilitate connection of the computing system 1000 to another system and/or device and may therefore include one or more serial, parallel, small computer system interface (SCSI), universal serial bus (USB), IEEE 1394 (e.g., Firewire™), and/or personal area network (PAN) components. The network interface devices 1008 may comprise the various components used to transmit and/or receive data over a network. By way of example, the network interface devices 1008 may include a device that can communicate both inputs and outputs, for instance, a modulator/demodulator (e.g., modem), wireless (e.g., radio frequency (RF)) transceiver, a telephonic interface, a bridge, a router, network card, etc.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Furthermore, the flow charts of FIGS. 2, 4, 6, 7, and 9 show the architecture, functionality, and/or operation of possible implementations of asynchronous client rendering system 110. In this regard, each block may represent a module, segment, or portion of code, which comprises one or more executable instructions for implementing the specified logical function(s). It should also be noted that in some alternative implementations, the functions noted in the blocks may occur out of the order noted in the figures. For example, two blocks shown in succession in the figures may in fact be executed substantially concurrently or the blocks may sometimes be executed in the reverse order, depending upon the functionality involved, as will be further clarified hereinbelow.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for providing asynchronous client rendering for a graphics system in a graphical user interface (GU:) environment, the method comprising the steps of:
rendering a component associated with a graphics system to a first buffer;
rendering at least one graphical element associated with a client of the graphics system to a second buffer; and
generating a composition of the first buffer and the second buffer.

2. The method of claim 1, wherein the component comprises one of a button and a window.

3. The method of claim 1, wherein the at least one graphical element comprises one of an image, text, and a graphics primitive.

4. The method of claim 1, wherein the second buffer comprises a transparent buffer.

5. The method of claim 1, wherein the step of generating a composition of the first buffer and the second buffer comprises superimposing the first buffer and the second buffer.

6. The method of claim 1, wherein the second buffer comprises a transparent pixel map.

7. The method of claim 6, wherein the step of generating a composition of the first buffer and the second buffer comprises overlaying the transparent pixel map and the component.

8. The method of claim 1, further comprising the steps of:
determining that the component is to be modified; and
rendering the modified component.

9. The method of claim 8, further comprising the step of generating a composition of the modified component and the second buffer.

10. A computer program embodied in a computer-readable medium for providing asynchronous client rendering for a graphics system in a graphical user interface (GUI) environment, the computer program comprising:
logic configured to render a component associated with a graphics system to a first buffer;
logic configured to render at least one graphical element associated with a client of the graphics system to a second buffer; and
logic configured to generate a composition of the component and the at least one graphical element.

11. The computer program of claim 10, wherein the component comprises one of a button and a window.

12. The computer program of claim 10, wherein the at least one graphical element comprises one of an image, text, and a graphics primitive.

13. The computer program of claim 10, wherein the second buffer comprises a transparent pixel map.

14. The computer program of claim 13, further comprising logic configured to generate a composition of the first buffer and the second buffer by overlaying the transparent pixel map and the component.

15. The computer program of claim 10, further comprising:
logic configured to determine that the component is to be modified;
logic configured to render the modified component; and
logic configured to generate a composition of the modified component and the second buffer.

16. An asynchronous client rendering system for a graphics system in a graphical user interface (GUI) environment, the system comprising:
memory comprising at least one component buffer configured to store a graphics context associated with a component and at least one transparent client buffer configured to store a graphics context for at least one graphical element associated with a client of a graphics system;
a component interface configured for enabling the component to be rendered to the at least one component buffer;
a client interface configured to enable the at least one graphical element to be rendered to the at least one component buffer; and
a component composition mechanism configured to generate a composition of the component and the at least one graphical element.

17. The asynchronous client rendering system of claim 16, wherein the component interface and the client interface comprise an application program interface.

18. The asynchronous client rendering system of claim 16, wherein the component comprises one of a button and a window.

19. The asynchronous client rendering system of claim 16, wherein the at least one graphical element comprises one of an image, text, and a graphics primitive.

20. The asynchronous client rendering system of claim 16, wherein the component composition mechanism is configured to generate the composition of the at least one component buffer and the at least one transparent client buffer by superimposing the component buffer and the transparent client buffer.

21. The asynchronous client rendering system of claim 16, wherein the at least one transparent client buffer comprises a transparent pixel map.

22. The asynchronous client rendering system of claim 21, wherein the component composition mechanism is configured to generate the composition of the at least one component buffer and the at least one transparent client buffer by overlaying the transparent pixel map and the component.

23. The asynchronous client rendering system of claim 16, wherein the component composition module is further configured to generate a composition of the transparent client buffer and a modified component re-rendered to the at least one component buffer.

24. An asynchronous client rendering system for a graphics system in a graphical user interface (GUI) environment, the system comprising:
a storage means for storing a graphics context associated with a component and a graphics context for at least one graphical element associated with a client of a graphics system;
a first interface means for enabling the component to be rendered to the storage means;
a second interface means for enabling the at least one graphical element to be rendered to the storage means; and
a means for generating a composition of the component and the at least one graphical element.

25. The asynchronous client rendering system of claim 24, wherein the means for generating a composition comprises a means for overlaying the component and the at least one graphical element.
